(19) United States
(12) Patent Application Publication
(10) Pub. No.: US 2017/0068451 A1
(43) Pub. Date: Mar. 9, 2017

(54) Storage Device and Method for Detecting and Handling Burst Operations

(71) Applicant: SanDisk Technologies Inc., Plano, TX (US)

(72) Inventors: Yuval Kenan, Nes Tziona (IL); Micha Yonin, Nes Tziona (IL)

(73) Assignee: SanDisk Technologies Inc., Plano, TX (US)

(21) Appl. No.: 14/871,575

(22) Filed: Sep. 30, 2015

Related U.S. Application Data
(60) Provisional application No. 62/215,526, filed on Sep. 8, 2015.

(51) Int. Cl. G06F 3/06

(52) U.S. Cl. CPC G06F 3/061; G06F 3/068; G06F 3/0655; G06F 3/0631

(57) ABSTRACT

A storage device and method for detecting and handling burst operations are provided. In one embodiment, a method for operating a storage device in burst mode is provided. The storage device senses a change in behavior of a host in communication with the storage device, determines whether the sensed change in behavior of the host is indicative of the host's need for the storage device to operate in burst mode by comparing the sensed change in behavior with prior changes in behavior that triggered prior burst modes in the storage device, and in response to determining that the sensed change in behavior of the host is indicative of the host's need for the storage device to operate in burst mode, operates the storage device in burst mode. Other embodiments are provided.

This application claims priority to U.S. provisional patent application No. 62/215,526, filed Sep. 8, 2015, which is hereby incorporated by reference herein.

### BACKGROUND

Storage devices may be used in different conditions, which place different performance requirements on the memory in the storage device. To account for these different conditions, memories in storage devices can be operated in a “normal” mode or in a “burst” mode, in which a higher-than-average performance by the storage device is required to satisfy a higher-than-average number of write commands from a host controller.

In general, burst mode is used in some memory devices to increase the speed of reading and writing data from and to the memory. Burst mode operation allows temporarily stopping of internal garbage collection operations to enable host writes from or to consecutive memory core locations at high speeds. Accordingly, a burst mode operation provides relatively-high data transfer rates (X1 performance) and significantly reduces the latency involved in host-storage device data transfer in a memory system environment, such as in those based on X3 memory architecture storing three-bits per cell. For example, when a storage device is part of a video camera host device, there might be a need by the host to provide higher write performance of host data (e.g., of video data) in the storage device's memory. As a result, the running application on the host increases the write capacity of data writes consumed (e.g., from multi-shots taken by the user), thereby requiring higher write performance to the device memory.

To achieve the higher-than-average performance, the host application can send a request or other indication to signal that the storage device should switch to a burst mode. In one example of burst mode, the storage device can write host data to a single-level cell (SLC) storage area (X1) instead of a multi-level cell (MLC) storage area (e.g., X3), as writing to SLC is faster than writing to MLC.

### BRIEF DESCRIPTION OF THE DRAWINGS

FIG. 1 is a block diagram of an exemplary storage device according to an embodiment.

FIG. 2A is a block diagram of a host according to an embodiment, where the exemplary storage device of FIG. 1 is embedded in the host.

FIG. 2B is a block diagram of the exemplary storage device of FIG. 1 but where it is removably connected to a host.

FIG. 3 is a graph of performance versus time of an embodiment in which variance is computed over a defined window frame.

FIG. 4 is a graph of performance versus time of an embodiment.

FIG. 5 is a block diagram of a host and storage device of an embodiment.

FIG. 6 is a block diagram of a RAM of an embodiment.

FIG. 7 is a block diagram of a controller of an embodiment.

FIG. 8 is a block diagram of a RAM of an embodiment.

FIG. 9 is a graph of logical addresses versus time of an embodiment.

### DETAILED DESCRIPTION

By way of introduction, the below embodiments relate to a storage device and method for detecting and handling burst operations. In one embodiment, a method for operating a storage device in burst mode is provided. The storage device senses a change in behavior of a host in communication with the storage device, determines whether the sensed change in behavior of the host is indicative of the host's need for the storage device to operate in burst mode by comparing the sensed change in behavior with prior changes in behavior that triggered prior burst modes in the storage device, and in response to determining that the sensed change in behavior of the host is indicative of the host's need for the storage device to operate in burst mode, operates the storage device in burst mode.

In some embodiments, to perform the comparing, the storage device uses a self-learning process that rates previous burst operations.

In some embodiments, the storage device rates previous burst operations according to an elapsed time between activation and deactivation of each burst operation. The storage device can also weight previous burst operations with a parameter indicative of an elapsed time since the burst operation occurred in the storage device.

In some embodiments, the storage device senses a change in behavior of the host by utilizing one or more configurable windows for measuring whether variance on storage device performance is above a threshold.

In some embodiments, the storage device senses a change in behavior of the host by performing pattern detection of data traffic from the host.

In some embodiments, the storage device senses a change in behavior of the host by measuring free blocks of internal queues in the storage device.

In some embodiments, the storage device senses a change in behavior of the host by monitoring host operations running in parallel on the host.

In some embodiments, when the storage device operates in burst mode, the storage device stores incoming host data in single level cells in the memory.

In some embodiments, the storage device comprises a buffer that is dynamically configurable to allow for adaptable sharing of buffer memory for servicing both host-initiated bursts and memory device-detected bursts.

In another embodiment, a storage device is provided comprising a memory and a controller. The controller is configured to receive a command from a host in communication with the storage device to write host data in the memory, detect a host need for the storage device to operate in a higher write performance mode by detecting a change of host usage, operate the storage device in the higher write performance mode, and perform a self-learning process to determine if the detected change of host usage justified operating the storage device in the higher write performance mode.

In some embodiments, the controller is configured to determine if the detected change of host usage justified operating the storage device in the higher write performance mode according to an elapsed time between activation and deactivation of the higher write performance mode.

In some embodiments, the controller is configured to detect a change of host usage by utilizing one or more configurable windows for measuring whether variance on storage device performance is above a threshold.

In some embodiments, the controller is configured to detect a change of host usage by performing pattern detection of data traffic from the host.

In some embodiments, the controller is configured to detect a change of host usage by measuring free blocks of internal queues in the storage device.

In some embodiments, the controller is configured to detect a change of host usage by monitoring host operations running in parallel on the host.

In some embodiments, the controller is configured to operate in a higher write performance mode by storing incoming host data in single level cells in the memory.

In some embodiments, the storage device further comprises a buffer that is dynamically configurable to allow for adaptable sharing of buffer memory for servicing both host-initiated bursts and memory device-detected bursts.

In another embodiment, a storage device is provided comprising a memory, a dynamically-configurable buffer, and a controller in communication with the memory and the buffer. The controller is configured to allocate a first amount of free blocks in the buffer for storing data for a memory-device detected burst, allocate a second amount of free blocks in the buffer for storing data for a host-initiated burst, and reclaim blocks allocated for storing data for a memory-device detected burst and reallocating those blocks for storing data for a host-initiated burst.

In some embodiments, the controller is further configured to reclaim the blocks in response to an amount of free blocks in the buffer falling below a threshold.

In some embodiments, the memory comprises a three-dimensional memory.

In some embodiments, the storage device is embedded in the host, while, in other embodiments, the storage device is removably connectable to the host.

Other embodiments are possible, and each of the embodiments can be used alone or together in combination. Accordingly, various embodiments will now be described with reference to the attached drawings.

The following paragraphs provide a discussion of an exemplary storage device (sometimes referred to as a storage module) that can be used with these embodiments. Of course, these are just examples, and other suitable types of storage devices can be used.

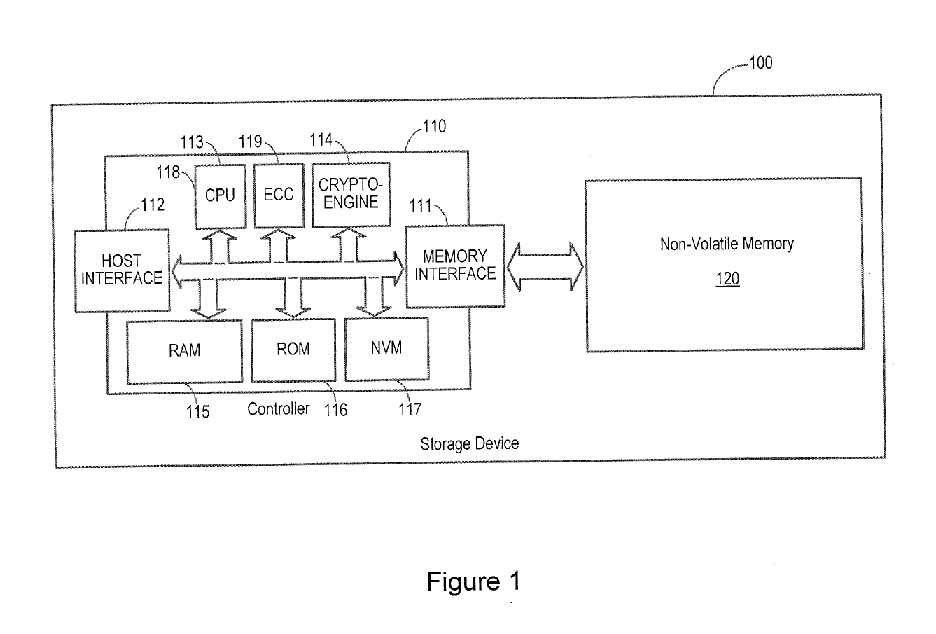

As illustrated in FIG. 1, a storage device 100 of one embodiment comprises a storage controller 110 and non-volatile memory 120. The storage controller 110 comprises a memory interface 111 for interfacing with the non-volatile memory 120 and a host interface 112 for placing the storage device 100 in communication with a host controller. As used herein, the phrase “in communication with” could mean directly in communication with or indirectly in (wired or wireless) communication with through one or more components, which may or may not be shown or described herein.

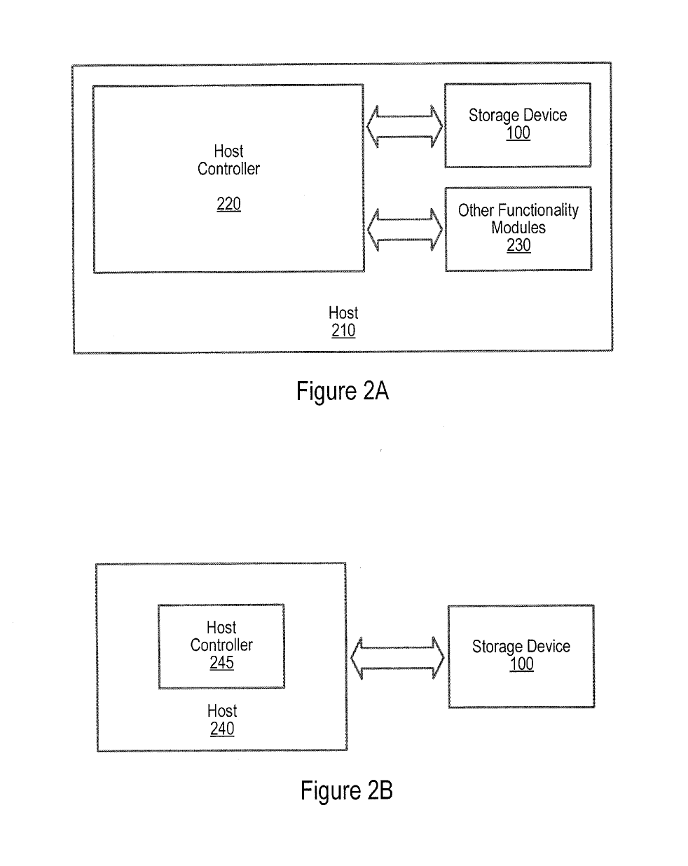

As shown in FIG. 2A, the storage device 100 can be embedded in a host 210 having a host controller 220. That is, the host 210 embodies the host controller 220 and the storage device 100, such that the host controller 220 interfaces with the embedded storage device 100 to manage its operations. For example, the storage device 100 can take the form of an iNAND™ eSD/eMMC embedded flash drive by SanDisk Corporation, or, more generally, any type of solid state drive (SSD), a hybrid storage device (having both a hard disk drive and a solid state drive), and a memory caching system. The host controller 220 can interface with the embedded storage device 100 using, for example, an eMMC host interface or a UFS interface. The host 210 can take any form, such as, but not limited to, a mobile phone, a tablet computer, a digital media player, a game device, a personal digital assistant (PDA), a mobile (e.g., notebook, laptop) personal computer (PC), or a book reader. As shown in FIG. 2A, the host 210 can include optional other functionality modules 230. For example, if the host 210 is a mobile phone, the other functionality modules 230 can include hardware and/or software components to make and place telephone calls. As another example, if the host 210 has network connectivity capabilities, the other functionality modules 230 can include a network interface. Of course, these are just some examples, and other implementations can be used. Also, the host 210 can include other components (e.g., an audio output, input-output ports, etc.) that are not shown in FIG. 2A to simplify the drawing. It should be noted that while the host controller 220 can control the storage device 100, the storage device 100 can have its own controller to control its internal memory operations.

As shown in FIG. 2B, instead of being an embedded device in a host, the storage device 100 can have physical and electrical connectors that allow the storage device 100 to be removably connected to a host 240 (having a host controller 245) via mating connectors. As such, the storage device 100 is a separate device from (and is not embedded in) the host 240. In this example, the storage device 100 can be a handheld, removable memory device, such as a Secure Digital (SD) memory card, a microSD memory card, a Compact Flash (CF) memory card, or a universal serial bus (USB) device (with a USB interface to the host), and the host 240 is a separate device, such as a mobile phone, a tablet computer, a digital media player, a game device, a personal digital assistant (PDA), a mobile (e.g., notebook, laptop) personal computer (PC), or a book reader, for example.

In FIGS. 2A and 2B, the storage device 100 is in communication with a host controller 220 or host 240 via the host interface 112 shown in FIG. 1. The host interface 112 can take any suitable form, such as, but not limited to, an eMMC host interface, a UFS interface, and a USB interface. The host interface 110 in the storage device 110 conveys memory management commands from the host controller 220 (FIG. 2A) or host 240 (FIG. 2B) to the storage controller 110, and also conveys memory responses from the storage controller 110 to the host controller 220 (FIG. 2A) or host 240 (FIG. 2B). Also, it should be noted that when the storage device 110 is embedded in the host 210, some or all of the functions described herein as being performed by the storage controller 110 in the storage device 100 can instead be performed by the host controller 220.

Returning to FIG. 1, the storage controller 110 comprises a central processing unit (CPU) 113, an optional hardware crypto-engine 114 operative to provide encryption and/or decryption operations, read access memory (RAM) 115, read only memory (ROM) 116 which can store firmware for the basic operations of the storage device 100, and a non-volatile memory (NVM) 117 which can store a device-specific key used for encryption/decryption operations, when used. As shown in FIG. 1, the RAM 115 stores a command queue, although, the command queue can be located in another location in the storage device 100. The storage controller 110 can be implemented in any suitable manner. For example, the storage controller 110 can take the form of a microprocessor or processor and a computer-readable medium that stores computer-readable program code (e.g., software or firmware) executable by the (micro)processor, logic gates, switches, an application specific integrated circuit (ASIC), a programmable logic controller, and an embedded microcontroller, for example. Suitable controllers can be obtained from SanDisk or other vendors. The storage controller 110 can be configured with hardware and/or software to perform the various functions described below and shown in the flow charts. Also, some of the components shown as being internal to the storage controller 110 can also be stored external to the storage controller 110, and other component can be used. For example, the RAM 115 (or an additional RAM unit) can be located outside of the controller die and used as a page buffer for data read from and/or to be written to the memory 120. The storage controller 110 also has an error correction code (ECC) engine 119 that can create ECC parity bits for data to be stored in the memory 120 and decode ECC parity bits for data read from the memory 120 in order to identify and/or correct errors in the data. The ECC engine 119 can also be used to detect errors in data transmitted to the storage controller 110 from the host controller.

The non-volatile memory 120 can also take any suitable form. For example, in one embodiment, the non-volatile memory 120 takes the form of a solid-state (e.g., NAND flash) memory and can be one-time programmable, few-time programmable, or many-time programmable. Also, the non-volatile memory 120 can be a two-dimensional memory or a three-dimensional memory. The non-volatile memory 120 can also use single-level cell (SLC), multiple-level cell (MLC), triple-level cell (TLC), or other memory technologies, now known or later developed.

As discussed above, some storage devices are configured to operate the memory in a “normal” mode or in a “burst” mode, in which a higher-than-average performance by the storage device is required to satisfy a higher-than-average number of write commands from a host controller. However, the switching of the storage device to burst mode usually requires involvement of the host and, as such, is initiated in response to an indication coming from the host (e.g., a command that triggers the device controller to increase the performance of host writes in the device memory). Accordingly, there is a need for an improved self-detected mechanism in the storage device that enables the storage device to temporarily switch to a higher write performance mode of operation. The following embodiments provide a novel and efficient way of identifying a need for operating a storage device in burst mode in such a way.

In one embodiment, the storage device 100 is configured to sense changes in host usage for detecting a host need to operate in a higher or lower write performance mode. For achieving this, the storage device 100 can detect and learn the changing host usage and host requirements in the system with respect to internal housekeeping operations within the device 100 and further with respect to the data pattern coming in from the host and other (external) data and system management operations done in the host. Some possible implementations of this are described below. Of course, these are just examples, and other implementations can be used.

In one example, upon identifying a need for increased host write performance, the storage device 100 switches to operate in burst mode to provide the host application with the required performance. In burst mode, the memory device controller 110 typically stores the incoming host data (incoming data patterns) in the SLC portion rather than the MLC portion of the memory 120, as writing to SLC cells is faster than writing to MLC cells. Alternatively, the host data can be written to a hybrid area in the memory 120 containing memory blocks that can be dynamically configured to operate as an SLC cell or MLC cell on demand.

Increasing the performance of host writes in the storage device 100 as such enables the storage device 100 to operate a 3-bit MLC (multi-level cell) X3 storage device with a 1-bit (X1) device performance, for example, or, for example, to operate a 2-bit MLC (multi-level cell) X2 storage device emulating a 1-bit SLC (single-level cell) X1 device performance.

Further, the storage device 100 may utilize a self-learning mechanism that is operative to learn the host behavior and to analyze required host usage in order to identify undesired performance, specifically with respect to worthy (host desired) and unworthy (not actually desired) bursts events. This allows the storage device 100 to predict possible changes in future host usage, while preventing unrequired activation of burst mode and undesired utilization of memory resources. Switching to burst operation in case of unworthy burst events is not worth the complexity of the design since it yields much lower performance with very little gain in burst duration, available memory capacity, and endurance.

To achieve this, the self-learning mechanism can rate the bursts events according to the burst duration time; that is, according to the elapsed time between the activation and deactivation of each burst event in the storage device 100, so that longer bursts events receive a higher rating in comparison to short time events. The rated burst event is then weighted with a parameter that is indicative of the elapsed time since the burst event actually occurred in the storage device 100, so that most recent bursts events receive a higher weight level than old events in the device. This provides the storage device 100 an indication of how much the host actually required increased write performance and, even if required, how much the host was actually capable of utilizing its memory resources for supporting the enhanced capacity. In other words, this allows the storage device 100 to learn about actual bursts events applied in the storage device 100 and to determine how much each such burst event was actually justified in terms of system performance and utilization of memory resources.

The following is a possible algorithm than can be performed by the controller 110 to perform the above operation. First, the controller 110 receives a host command, e.g., for writing of host data to/from the memory 120. Then, sensing the changing host usage, the controller 110 detects a host need to operate in higher or lower write performance. In one embodiment, the controller 110 detects changes of host usage and host requirements in the storage device 100 with respect to internal housekeeping operations within the storage device 100 and/or with respect to other (external) data and system management operations done in the host.

Upon identifying a need and/or capability of the host to operate in higher write performance (e.g. ˜40 MB), the controller 110 switches to burst mode of operation in which the storage device 100 operates to write host data to X1 storage area (or storage partition) only while temporarily delaying the step of copying or folding to MLC storage area (e.g. X3 area). In such case, the X1->to X3 folding is typically done while reclaiming idle time recovery from the host after the storage device 100 leaves burst mode (e.g., system idle time recovery). Next, the controller 110 performs self-learning of previous bursts events in the storage device 100 by rating and weighting the bursts operations over time, as described above, for identifying worthy and unworthy bursts events. Then, utilizing this information, the controller 110 prevents unrequired future activation of burst mode and undesired utilization of memory resources.

The controller 110 can sense the write performance required by the host is any suitable way. The following are some examples, but it should be noted that other implementations can be used. In one example, the controller 110 senses the write performance of the host by utilizing a configurable window frame for measuring the variance on the system performance and/or the system performance. The window frame may be configurable according to the changing host usage, characteristics of running applications, and other system environment parameters. Utilizing a configurable window frame for measuring the performance or the variance on the system performance as such provides the storage device 100 with an indication of the typical behavior of the host (host usage).

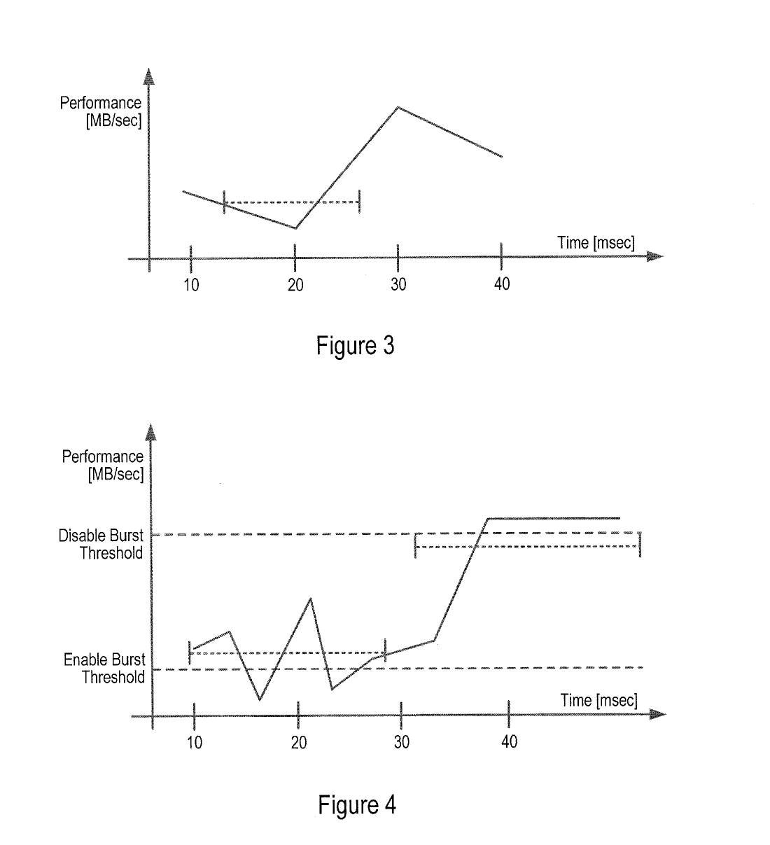

For example, in case the variance that is computed over a defined window frame (say, 10 msec; see FIG. 3) is below a threshold value (enable burst threshold) and the write performance measured in the host is relatively low then, this means that the host is requiring higher write capacity. In such case, the storage device 100 can switch to operating in burst mode, allowing the host to operate in higher capacity. In order to determine when to stop operating in burst mode, the storage device 100 may use a second threshold value (disable burst threshold) to make sure that the storage device 100 operates in burst mode as long as the measured system variance does not exceed the disable threshold value. Since the write performance and variance on the system performance are higher during operation in burst mode, the disable threshold value is typically higher than the enable burst threshold. Note that the enable threshold and disable threshold may be configurable and adaptable according to the weight and rating of the previous bursts events applied in the storage device, by using the learning mechanism described above.

In another example, if the measured performance over time, say across one or more configurable window frames, is above a threshold value (enable burst threshold) then the controller 110 can switch to operating in burst mode, allowing the host to operate in higher capacity. In burst mode, if the measured performance over time is below a second threshold value (disable burst threshold), then this means that the storage device 100 is operating in a desired host performance and, as a result, disables burst mode and switches to regular operation mode. This is shown in the graph of FIG. 4.

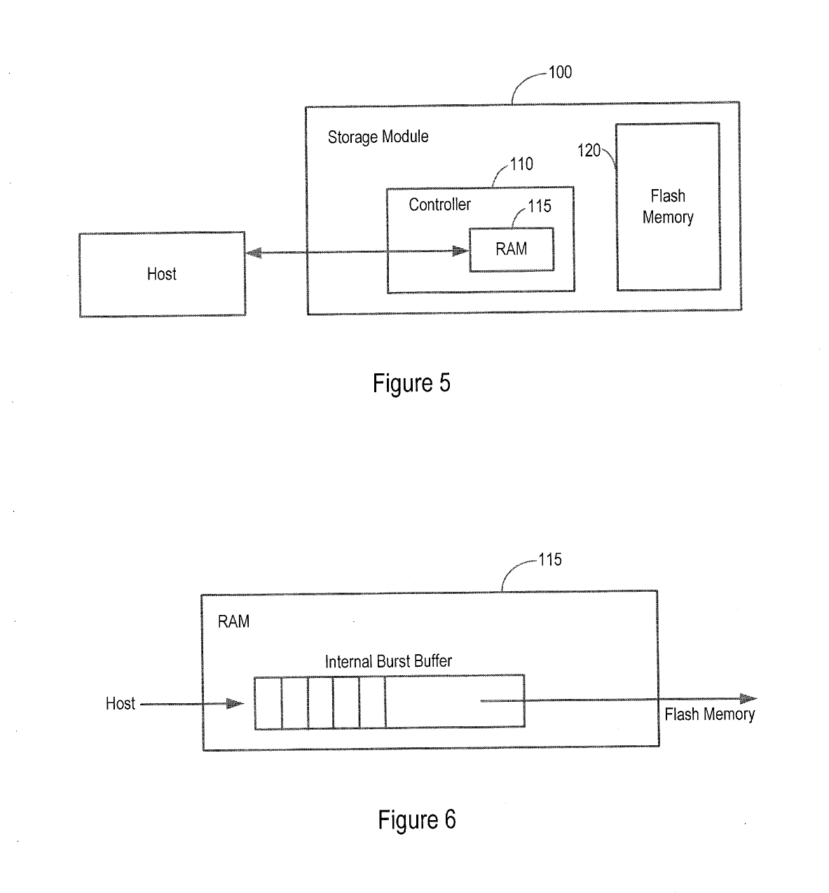

According to another embodiment, sensing the write performance of the host may be done by monitoring the storage device 100 performance over time. This can be achieved by performing pattern detection of data traffic in internal buffers or queues in the device memory. For example, sensing the write performance of the host can be achieved by measuring the free blocks of the internal burst buffers in the RAM that are allocated for holding pending host writes (bursts) operations. The occupied storage space of these internal buffers and the amount of pending host write operations in the burst buffer or burst operation queue provides an indication about the operating rate of the storage device 100 in comparison to the requested operating rate of the host. In other words, the amount of occupied/free storage space in the internal buffer provides an indication of the storage device performance versus host performance. This allows for the storage device 100 to determine which system module is operating at a faster rate—the host or the storage device 100. For example, if the internal burst buffer is above a certain threshold of free blocks (say, 80%), then this means that the device controller 110 is the bottleneck in the host-device data transfer process in the system. In such case, the storage device 100 can switch to operating in burst mode. In this case, bursts of host writes coming in from the host are maintained as pending operations in an internal queue buffer in the RAM 115, and then written by the device controller 110 to the flash memory 120, as shown in FIGS. 5 and 6.

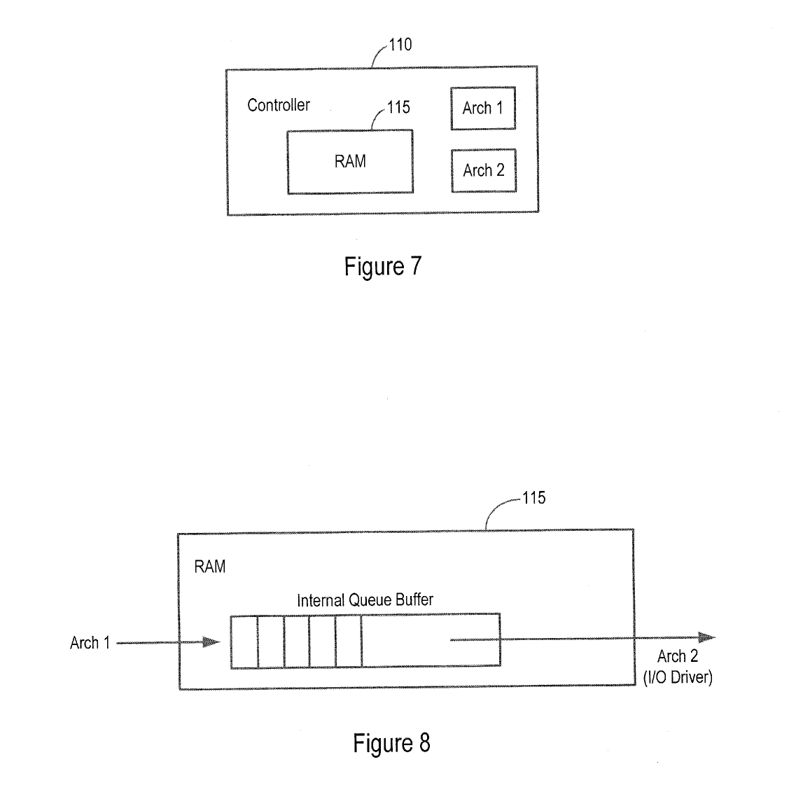

In another example, sensing the write performance of the host is achieved by measuring the free blocks of internal queues between various firmware modules (say, between high level and low level modules) in the storage device 100. Such firmware modules maintain an internal queue of internal pending operations in the device. Such queues may be provided to hold any pending housekeeping operations, firmware threads associated with memory access events or tasks, or any other internal operations for access to the RAM memory. With reference to FIG. 7, Arch 1 in the controller 110 is an internal, high-level firmware module in the storage device 100 operative to receive host writes, and Arch 2 is a low-level firmware module, such as an I/O driver, that activates the I/O bus of the storage device 100 in association with the pending operations.

In yet another possible implementation, sensing the write performance of the host may be done by monitoring the host operations or host processes running in parallel on the host and accelerating those host processes of identified applications that actually require enhanced performance. This may be achieved by identifying for the different host processes the rate at which the streams of data writes for each process are communicated to the device and then analyzing the rates at which the different streams of data writes are received by the storage device 100 and handling them accordingly. For example, in the case the storage device 100 receives multiple streams of data coming in parallel at different rates from different processes on the host at different rates, the storage device 100 can analyze the rate at which logical addresses associated with streams of data of different host processes are received by the storage device 100 to identify host processes requiring operation in high performance. For the identified host processes, the storage device 100 can switch to operating in burst mode, where it accelerates the write performance of those streams of data for the identified host process within the storage device 100.

To distinguish between the multiple streams of data and associated transfer rate, the storage device 100 may utilize various stream detection algorithms on the logical addresses coming in from the host. The string detection algorithm involves linking between previous logical addresses and upcoming logical addresses for distinguishing between the multiple streams of data and in order to enable associating the streams of data to their respective host processes. Another way for achieving this may be through the Context ID specified by the host with each host write operation. For example, the host can specify a different Context ID for each application or process running on the host. This allows for the storage device 100 to distinguish between the multiple streams of data and further to associate the streams of data to their respective host processes.

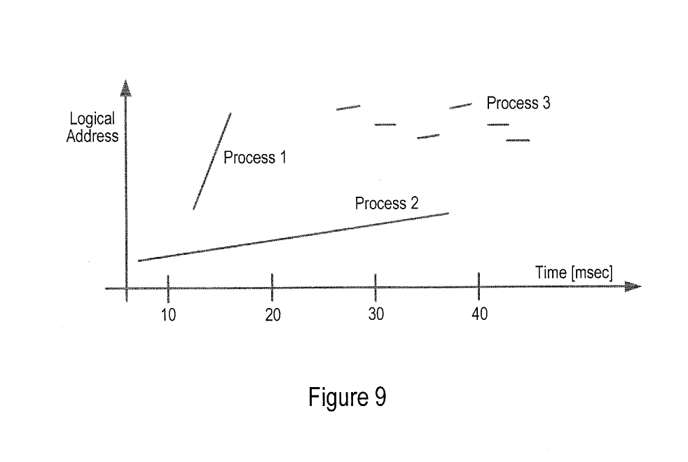

With reference to FIG. 9, Process 1 describes a situation where many LBA (logical block address) ranges of multiple streams of data are received in by the storage device 100 at a short period of time. Thus, Process 1 requires acceleration of the storage device 100 to burst mode. Process 2 describes a long stream of data coming in at a relatively long period of time, and such case does not justify burst mode. Process 3 describes a typical situation of data updates, and such case does not justify burst mode.

There are many advantages associated with these embodiments. For example, these embodiments allow the storage device 100 to provide higher write performance in operation with the host in an autonomous manner and in a way that is transparent to the host. That is, detecting a host need and host capability to achieve higher write performance internally by the storage device 100 without the need for obtaining a special indication (host command) from the host to switch to burst mode. This allows for designing a storage device with a burst mode supported feature in an autonomous manner and transparent to the host (e.g., without receiving a command from the host to enter burst mode).

There are many alternatives that can be used with these embodiments. For example, one alternate embodiment involves a way of handling shared memory resources in the storage device 100 for supporting different types of burst mode operation modes in the storage device 100 (typically host-initiated burst and device-detected burst) in a way that is transparent to the host and does not affect its operation. More specifically, in this embodiment, the storage device 100 is designed with a burst buffer that is dynamically configured to allow for adaptable sharing of memory resources for servicing both host-initiated bursts (“type A”) and device-detected bursts (“type B”) in an effective way, according to the dynamic host usage and changing system requirements. Such storage device configuration allows the host controller and host application to receive its required bandwidth and use it efficiently between the different types of burst-modes in a changing system environment in a way that is transparent to the host.

In the context of this embodiment, a “host-initiated burst” or “host-initiated burst-mode” [type A] refers to an operational state of the storage device 100, wherein the storage device 100 is invoked to operate in burst mode to service host-initiated burst operations in response to a request or indication that is sent out from the host to the storage controller 110 to increase the performance of host writes in the storage device 100. Accordingly, to “service host-initiated burst operations” typically refers to the storing of data associated with incoming host write commands in a memory space in the burst buffer in the storage device 100 that is reclaimed for host-initiated burst, where the host commands are transmitted to the storage device 100 from the host during operation of the storage device 100 in host-initiated burst.

A “device-detected burst” or “device-detected burst-mode” [type B] refers to an operational state of the storage device 100, wherein the storage device 100 switches to operate in burst mode to service device-detected burst operations upon identifying a need for increased host write performance in an autonomous manner, transparently to the host. Thus, “service device-detected burst operations” typically refers to the storing of data associated with incoming host write commands in a memory space in the burst buffer in the storage device 100 that is reclaimed for device-detected burst, where the host commands are transmitted to the storage device 100 from the host during operation of the storage device 100 in device-detected burst.

To enable shared resources of the storage device memory 120 between the different types of burst-modes, the memory 120 can be designed to support a dynamic configuration, where the burst buffer can be used or reclaimed to service different types of burst operations on demand, according to the changing needs and usages made by the host.

In one embodiment, a first amount of free blocks of the burst buffer is allocated to serve type A burst-mode (e.g. device-detected burst) and a second amount of free blocks of the burst buffer can be allocated to serve type B burst mode (host-initiated burst). In case at some point using the free blocks allocation in the type A burst mode type as such creates available space for storing additional information, the free blocks reclaimed to service type A burst-mode can be either partially or fully, dynamically re-allocated to service type B bursts. This allows for type B burst events to maximize its performance and thereby increase the capacity of data handled by the host application during operation of the storage device in type B burst-mode.

Such adaptive burst mode technique can be implemented for use in the storage device in any suitable manner. For example, in one implementation, the burst buffer in the storage device 100 can be dynamically configured with the entire burst buffer memory space allocation (say, 100 MBytes) initially reclaimed to service type B (device-detected) burst operations. Such allocation may be determined during production phase of the storage device 100, for example. This initially allows for the storage device 100 to service type B device-detected host needs for burst operations without limiting the capacity of data associated with the incoming write commands and without limiting the bandwidth required by the host applications during operation of the storage device 100 with the host in this type of burst-mode.

Optionally, to serve type A (host-initiated) burst operations, a certain number of blocks in the burst buffer can be further reclaimed to service type A host-initiated burst operations. Such reclaimed blocks in the burst buffer may be utilized by the storage device 100 during type A host-initiated burst in a variety of ways, according to the specific implementation. For example, this reclaimed block may be utilized by the storage device 100 at all times or, for example, only in case the amount of free blocks in the burst buffer do not reach a minimal defined threshold (e.g., minimum number of available block units). Then, the amount of free blocks reclaimed for servicing data writes in type A (host-initiated) burst may be dynamically updated by the storage device 100 according to the amount of free blocks that are left unused during type B (device-detected) burst mode and further based on the host usage and other changing host requirements.

For achieving this, the storage device 100 may implement a self-learning mechanism that is operative to learn the host behavior and to analyze required host usage in order to identify desired host performance. This further allows the storage device 100 to predict possible changes in future host usage, specifically with respect to worthy (host desired) and unworthy (not actually desired) bursts events, while preventing unrequired activation of burst mode and undesired utilization of memory resources. Switching to burst operation in case of unworthy burst events is not worth the complexity of the design since it yields much lower performance with very little gain in burst duration, available memory capacity, and endurance.

For achieving this, the self-learning mechanism can rate the bursts events according to the burst duration time; that is, according to the elapsed time between the activation and deactivation of each burst event in the storage device 100, so that longer bursts events receive a higher rating in comparison to short time events. The rated burst event is then weighted with a parameter that is indicative of the elapsed time since the burst event actually occurred in the storage device 100, so that most recent bursts events receive a higher weight level than old events in the storage device 100. This provides the device an indication of how much the host actually required increased write performance and, even if required, how much the host was actually capable of utilizing its memory resources for supporting the enhanced capacity. In other words, this allows the storage device 100 to learn about actual bursts events applied in the storage device 100 and to determine how much each such burst event was actually justified in terms of system performance and utilization of memory resources.

Alternatively or additionally, such parameters can be communicated to the storage device 100 from the host, for example during initial operation of the storage device 100 with the host, and processed internally in the storage device 100.

The following is an exemplary algorithm that the controller 110 can use to perform the above functions. Of course, this is just an example, and other algorithms can be used.

In this embodiment, the controller 110 allocates a burst buffer in the memory 120, where the burst buffer contains a first amount of free block that are reclaimed for servicing (i.e. storing) data in type B burst mode, say device-detected burst-mode, and a second amount of free blocks that are reclaimed in the burst buffer for servicing type A burst-mode, say host-initiated burst. Note that the burst buffer may be configured with a shared amount of free blocks to service either type B (device-detected) burst or type A (host-initiated burst), depending on the particular operational state of the storage device 100, so that there is an overlap of a certain percentage (e.g., 10%, 30%, etc.) of free blocks in the burst buffer for servicing either type of burst, as required. One advantage with such approach is that it provides the host dynamic control over a certain percentage (e.g., 10%, 30%, etc.) of the free blocks in the burst buffer according to the host's changing requirements. Also note that the amount of free blocks reclaimed to service type A (host-initiated) bursts may be pre-configured in the storage device 100, for example during production, or communicated to the storage device 100 from the host, for example during initial operation of the storage device with the host.

In type B (device-detected) burst mode, the controller 110 can communicate with the host controller to receive the data associated with the plurality of write commands that are to be executed in the storage device 100 for storage in the burst buffer in the memory 120. The data is stored in the free blocks in the burst buffer in the area that is reclaimed for type B burst mode. Then, the controller 110 identifies free blocks in the burst buffer that are reclaimed but not utilized for type B and reclaims these unutilized free blocks to service type A (host-initiated) burst operations. In addition, the controller 110 can monitor host usage and changing system requirements, transparently to the host (that is, without involvement of the host). As noted above, monitoring of host usage and changing system requirements can involve monitoring—and possibly also predicting—host erase operations of burst data, internal cleanup operations, garbage collection operations, internal backup operations, among other housekeeping and backup operations in the host. This can further involve monitoring and sensing of internal housekeeping operations carried out in the storage device 100.

Upon sensing a change in the host usage and system requirements, the controller 110 can dynamically update the allocation of the reclaimed blocks in the burst buffer according to the host usage and further based on the amount of unutilized, free blocks identified above.

Of course, other alternatives are possible. For example, in order to provide a more efficient use of the memory resources and to increase the capacity of the host data handled by the application, the controller 110 may be capable to operate in one of several burst-mode levels of operation that can differ from one another in various performance/capacity tradeoffs that can be dynamically chosen to fit a given host requirement. Each burst mode level may be applied for supporting a different write performance level and different supported overall data capacity, for example. Such may be applicable in the storage device 100 operating either in device-detected burst mode or in host-initiated burst mode; that is, for servicing both device-detected burst operations and host-initiated burst operations. In such case, the storage device 100 may be configured to operate in one or more of a plurality of burst-mode levels that can differ from one another in one or more characteristics. This may result in various performance/capacity tradeoffs that can be dynamically chosen, typically by the storage device, to fit the changing host requirements and dynamic host usage. The storage controller 110 may be configured to choose one of a plurality of burst-mode levels to use in any suitable way. For example, the storage controller 110 can choose the preferred burst-mode level in which to operate the storage device 100 based on how many write commands are stored in the burst buffer area reclaimed for the particular burst-mode type. Alternatively, the storage controller 110 may be configured to choose one of a plurality of burst-mode levels based on a performance profile and other input received from the host.

The plurality of burst mode levels can be discrete with a fixed number of burst mode levels, or the plurality of burst-mode levels can provide a continuous performance range. Moreover, in order to maximize the storage rate of burst, the internal folding process (slower process) of the data from the SLC storage area (D1) to MLC area (D3), if such is required, and other garbage collection operations can be temporarily delayed or avoided in the device during in burst mode.

There are several advantages associated with these embodiments. For example, these embodiments allow the storage device 100 to share its memory resources in an efficient for servicing different types of bursts operations (that is, host-initiated burst operations and device-detected burst operations), according to the host usage and changing host requirements, without affecting the host operation and further in a way that is transparent to the host. This allows the storage device 100 to provides better performance upon demand

Finally, as mentioned above, semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured.

The semiconductor memory elements located within and/or over a substrate may be arranged in two or three dimensions, such as a two dimensional memory structure or a three dimensional memory structure.

In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three dimensional exemplary structures described but cover all relevant memory structures within the spirit and scope of the invention as described herein and as understood by one of skill in the art.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

What is claimed is:

1. A method for operating a storage device in burst mode, the method comprising:
performing the following in a storage device comprising a memory, wherein the storage device is configured to selectively operate in burst mode:
sensing a change in behavior of a host in communication with the storage device;
determining whether the sensed change in behavior of the host is indicative of the host's need for the storage device to operate in burst mode by comparing the sensed change in behavior with prior changes in behavior that triggered prior burst modes in the storage device; and
in response to determining that the sensed change in behavior of the host is indicative of the host's need for the storage device to operate in burst mode, operating the storage device in burst mode.

2. The method of claim 1, wherein to perform the comparing, the storage device uses a self-learning process that rates previous burst operations.

3. The method of claim 2, wherein the storage device rates previous burst operations according to an elapsed time between activation and deactivation of each burst operation.

4. The method of claim 2, wherein the storage device also weights previous burst operations with a parameter indicative of an elapsed time since the burst operation occurred in the storage device.

5. The method of claim 1, wherein the storage device senses a change in behavior of the host by utilizing one or more configurable windows for measuring whether variance on storage device performance is above a threshold.

6. The method of claim 1, wherein the storage device senses a change in behavior of the host by performing pattern detection of data traffic from the host.

7. The method of claim 1, wherein the storage device senses a change in behavior of the host by measuring free blocks of internal queues in the storage device.

8. The method of claim 1, wherein the storage device senses a change in behavior of the host by monitoring host operations running in parallel on the host.

9. The method of claim 1, wherein when the storage device operates in burst mode, the storage device stores incoming host data in single level cells in the memory.

10. The method of claim 1, wherein the storage device comprises a buffer that is dynamically configurable to allow for adaptable sharing of buffer memory for servicing both host-initiated bursts and memory device-detected bursts.

11. The method of claim 1, wherein the memory comprises a three-dimensional memory.

12. The method of claim 1, wherein the storage device is embedded in the host.

13. The method of claim 1, wherein the storage device is removably connectable to the host.

14. A storage device comprising:
a memory; and
a controller in communication with the memory, wherein the controller is configured to:
receive a command from a host in communication with the storage device to write host data in the memory;
detect a host need for the storage device to operate in a higher write performance mode by detecting a change of host usage;
operate the storage device in the higher write performance mode; and
perform a self-learning process to determine if the detected change of host usage justified operating the storage device in the higher write performance mode.

15. The storage device of claim 14, wherein the controller is configured to determine if the detected change of host usage justified operating the storage device in the higher write performance mode according to an elapsed time between activation and deactivation of the higher write performance mode.

16. The storage device of claim 14, wherein the controller is configured to detect a change of host usage by utilizing one or more configurable windows for measuring whether variance on storage device performance is above a threshold.

17. The storage device of claim 14, wherein the controller is configured to detect a change of host usage by performing pattern detection of data traffic from the host.

18. The storage device of claim 14, wherein the controller is configured to detect a change of host usage by measuring free blocks of internal queues in the storage device.

19. The storage device of claim 14, wherein the controller is configured to detect a change of host usage by monitoring host operations running in parallel on the host.

20. The storage device of claim 14, wherein the controller is configured to operate in a higher write performance mode by storing incoming host data in single level cells in the memory.

21. The storage device of claim 14 further comprising a buffer that is dynamically configurable to allow for adaptable sharing of buffer memory for servicing both host-initiated bursts and memory device-detected bursts.

22. The storage device of claim 14, wherein the memory comprises a three-dimensional memory.

23. The storage device of claim 14, wherein the storage device is embedded in the host.

24. The storage device of claim 14, wherein the storage device is removably connectable to the host.

25. A storage device comprising:
a memory;
a dynamically-configurable buffer; and
a controller in communication with the memory and the buffer, wherein the controller is configured to:
allocate a first amount of free blocks in the buffer for storing data for a memory-device detected burst;
allocate a second amount of free blocks in the buffer for storing data for a host-initiated burst; and
reclaim blocks allocated for storing data for a memory-device detected burst and reallocating those blocks for storing data for a host-initiated burst.

26. The storage device of claim 25, wherein the controller is further configured to reclaim the blocks in response to an amount of free blocks in the buffer falling below a threshold.

27. The storage device of claim 25, wherein the memory comprises a three-dimensional memory.

28. The storage device of claim 25, wherein the storage device is embedded in the host.

29. The storage device of claim 25, wherein the storage device is removably connectable to the host.
